(19) United States
(12) Patent Application Publication
(10) Pub. No.: US 2010/0062301 A1
(43) Pub. Date: Mar. 11, 2010

(54) SYSTEM HAVING HIGH-TEMPERATURE FUEL CELLS

(76) Inventor: Rudolf Hendriks, Velp (NL)

Correspondence Address: BROWDY AND NEIMARK, P.L.L.C.;624 NINTH STREET, NW, SUITE 300, WASHINGTON, DC, 20001-5303, US

(21) Appl. No.: 12/515,688

(22) PCT Filed: Nov. 20, 2006
(86) PCT No.: PCT/NL06/00580

§ 371 Date: Oct. 1, 2009

(51) Int. Cl. H01M 8/04; H01M 8/10

(52) U.S. Cl. 429/26; 429/30

(57) ABSTRACT

System having a plurality of high-temperature fuel cells connected in series for generating at least electrical energy, in particular having solid oxide fuel cells (SOFCs), which system comprises: -an air source for air, -a fuel source for a fuel, for example natural gas, -at least a first and a second high-temperature fuel cell, which are connected in series, each fuel cell comprising an anode inlet for fuel, and an anode outlet, as well as a cathode inlet for air, and a cathode outlet, as well as an electrical connection for outputting electrical energy which has been generated, -the cathode inlet of the first fuel cell being connected to the air source, -the anode inlet of each fuel cell being connected to the fuel source, -the cathode outlet of the first fuel cell being connected to the cathode inlet of the second fuel cell, -and a bypass air connection for air being provided between the air source, on the one hand, and, on the other hand, an admixing port between the cathode outlet of the first fuel cell and the cathode inlet of the second fuel cell.

The invention relates to a system having a plurality of series-connected high-temperature fuel cells, in particular solid oxide fuel cell (SOFC) type fuel cells, for generating at least electrical energy.

It is known from the prior art that high-temperature fuel cells are suitable for “large-scale (decentralized) energy generation”. Fuel cells of this type, which at present are deemed to encompass MCFCs (Molten Carbonate Fuel Cells) as well as SOFCs, have an operating temperature above 600 degrees Celsius, and in the case of SOFC fuel cells preferably between 650-1000 degrees Celsius. The air serves to supply oxygen to the fuel cell, and the fuel used to provide hydrogen may, for example, be natural gas or hydrogen which has already been produced.

Known systems which incorporate fuel cells of this type are not especially satisfactory. The invention does not relate to the design and production of the fuel cells of this type, but rather the way in which they are integrated in a system for energy generation.

It is an object of the invention to provide a system which allows efficient use to be made of high-temperature fuel cells.

Another object of the present invention is to propose measures which lead to an improved system.

In particular, it is an object of the invention to provide a system of higher efficiency than the known systems. Another object of the invention is to propose measures which allow optimum use to be made of the heat in exhaust gases from the system.

Yet another object is to provide a system with lower levels of polluting emissions than the known systems.

Yet a further object is to provide a system in which optimum operating conditions are created for one or more of the components of the system, which is particularly advantageous for the technical implementation of the component(s) in question.

The invention provides a system according to claim 1. By way of example, the fuel cells are intended for an air supply which provides air at approximately 900 degrees Celsius. The measures of the claim ensure that the effluent from the cathode outlet of the first fuel cell, which is at a temperature of, for example, around 1100 degrees, is admixed with “cool air”, for example at approximately 600 degrees Celsius, so that the temperature of the air which is fed to the second fuel cell is once again 900 degrees Celsius. This makes it possible to incorporate a considerable fuel cell power in a system which provides optimum conditions for each cell.

It will be clear that the series may also comprise more than two high-temperature fuel cells, in which case the “air admixing approach” is repeated for each fuel cell and each fuel cell in turn receives air supplied at the correct temperature.

The fuel source is preferably connected to the anode inlet of the first fuel cell, and the anode outlet of the first fuel cell is preferably connected to the anode inlet of the second fuel cell, resulting in a “series connection” in terms of the way in which the fuel is supplied to the fuel cells.

Between the air source and the cathode inlet of the first fuel cell, the system preferably comprises a preheating-combustion device for heating air originating from the air source, so that heated air is fed to the first fuel cell. This preheating-combustion device may in particular also be useful when starting up the system.

In an advantageous embodiment, the preheating-combustion device is connected to the anode outlet of one or more fuel cells, preferably of the first fuel cell in the series.

In an advantageous embodiment, the system comprises a turbine which is connected to the cathode outlet of the last fuel cell of the series, so that the energy in the high-temperature gases which come out of it can be used to drive the turbine.

In particular if the system comprises a turbine which is connected to the cathode outlet of the last fuel cell in the series, or one or more other cathode outlets of the series, it is advantageous for the system to comprise a bypass air connection for air between the air source and the cathode outlet of said fuel cell(s) of the series of fuel cells which is/are connected to the turbine. It is in this way in turn possible to lower the temperature, for example to approximately 900 degrees Celsius, which is advantageous for the design and operation of a turbine of this type.

The system preferably comprises a compressor assembly for compressing air, having at least one compressor with an air inlet and an outlet which is connected to the cathode inlet of the first fuel cell of the series, so that compressed air is fed to the fuel cell series.

The compressor assembly preferably comprises:
a low-pressure compressor with an air inlet and an outlet,
a high-pressure compressor with an inlet and an outlet, the outlet of the low-pressure compressor being connected via a primary air path to the inlet of the high-pressure compressor.

It is preferable for the system to comprise a compressor turbine assembly for driving the compressor assembly, which compressor turbine assembly comprises a single compressor turbine or a plurality of compressor turbines positioned in series, which compressor turbine assembly has an inlet and an outlet, the inlet being connected to the cathode outlet of the last fuel cell of the series.

The generation of energy is preferably also realized by virtue of the system also comprising a power turbine with a rotatable shaft for outputting mechanical energy, preferably connected to an electric generator for generating electrical energy.

It is preferable for the power turbine to have an inlet which is connected to the outlet of the compressor turbine assembly, and an exhaust gas outlet.

In the system, it is possible for a combustion device to be disposed between the outlet of the compressor turbine assembly and the inlet of the power turbine.

In a variant, one or more high-temperature fuel cells, preferably a series of high-temperature fuel cells as explained above, are disposed between the outlet of the compressor turbine assembly and the inlet of the power turbine.

In a system having a power turbine, the system preferably comprises an exhaust gas pipe system, an inlet end of which is connected to the exhaust gas outlet of the power turbine.

In a system having a low-pressure compressor and a high-pressure compressor, the system preferably comprises a secondary air path, which at an inlet end thereof is connected between the outlet of the low-pressure compressor and the inlet of the high-pressure compressor, in such a manner that, of the compressed air coming out of the outlet of the low-pressure compressor, a primary air stream passes via the primary air path to the high-pressure compressor and a secondary air stream enters the secondary air path,
and wherein it is preferable for water injection means to be provided at the secondary air path, for injecting water into the secondary air stream,
and wherein the secondary air path, at an outlet end thereof, is connected to the connection between the outlet of the compressor turbine assembly and the inlet of the power turbine.

The secondary air path may if appropriate incorporate a fan for increasing the pressure of the secondary air stream.

It is preferable for the preheating of the air which is supplied to be effected (partly) on the basis of a heat exchanger which makes use of heat in exhaust gases from the system and which is provided, for example, between the compressor assembly and the series of high-temperature fuel cells.

It is particularly preferable for the invention to provide for the system to comprise one or more steam generators for generating steam, in which case a steam generator is preferably connected to the exhaust gas pipe system for the purpose of making use of heat from the exhaust gases in order to create steam, the steam generator having an outlet which is connected to the anode outlet of one or more of the fuel cells, preferably to an admixing port in the connection between the anode outlet of a fuel cell and the anode inlet of a fuel cell. This makes it possible to maintain optimum operating conditions at that point too.

It will be clear that if a plurality of fuel cells are connected in series, steam admixing of this type may in each case take place between interconnected anode outlet and anode inlet.

The invention preferably also provides a solution in which the system comprises a steam generator for generating steam, wherein the steam generator is preferably connected to the exhaust gas pipe system for utilizing heat from the exhaust gases to create steam, and wherein the steam generator has an outlet which is connected to the cathode outlet of the last fuel cell in the series. This is particularly advantageous if said outlet is connected to a turbine and this solution could also be used if one or more other cathode outlets of the series are connected to a turbine.

In a system having a low-pressure compressor and a high-pressure compressor, optimum operating conditions for the high-pressure compressor can be realized by dividing the air stream coming out of the low-pressure compressor into a primary air stream and a secondary air stream, while water may expediently also be injected into the secondary air stream.

In one possible variant, the system comprises cooling means which cool the primary air stream; these cooling means may be designed as water injection means, which are then independent of the water injection means for the secondary air stream.

It is preferable for the primary air stream to be larger than the secondary air stream; by way of example, the primary air stream amounts to 70-90% and the secondary air stream amounts to 10-30% of the total air stream output by the low-pressure compressor.

The secondary air stream can be combined with the primary air stream downstream of an optional compressor turbine assembly of the system, so that said secondary air stream can be held at a relatively low pressure. If the pressure at the point at which the two air streams are combined is higher than at the outlet of the low-pressure compressor, it is possible to provide a fan, an auxiliary compressor, which raises the pressure of the secondary air stream. By way of example, this fan is an electrically driven fan.

It is preferable to provide a heat exchanger which effects heat transfer between the exhaust gases in the exhaust gas pipe system, on the one hand, and the secondary air stream, on the other hand, preferably downstream of the first water injection means. This makes it possible to introduce the maximum possible quantity of water into the secondary air stream and to evaporate this water using heat from the exhaust gases.

It should be noted that the term “water injection” in the context of the present invention comprises any form of injection of water, i.e. including the atomization of water, the injection of preheated water or of steam, etc.

One possible use of the system of the invention is “decentralized energy generation” for a (process) installation (for example in the petrochemical industry) or for a building, residential area, etc.

In one particular variant, the invention provides for the system to be located in a “natural gas production field, close to one or more natural gas wells, preferably within a radius of 10 km from natural gas production wells of this type, if appropriate directly at a natural gas production well. By way of example, it is in this way possible to make use of natural gas originating from wells which are not (no longer) of interest for the production of natural gas, for example on account of the pressure level being or having become too low.

Further advantageous embodiments of the system according to the invention are described in the claims and the following description with reference to the drawing, in which:

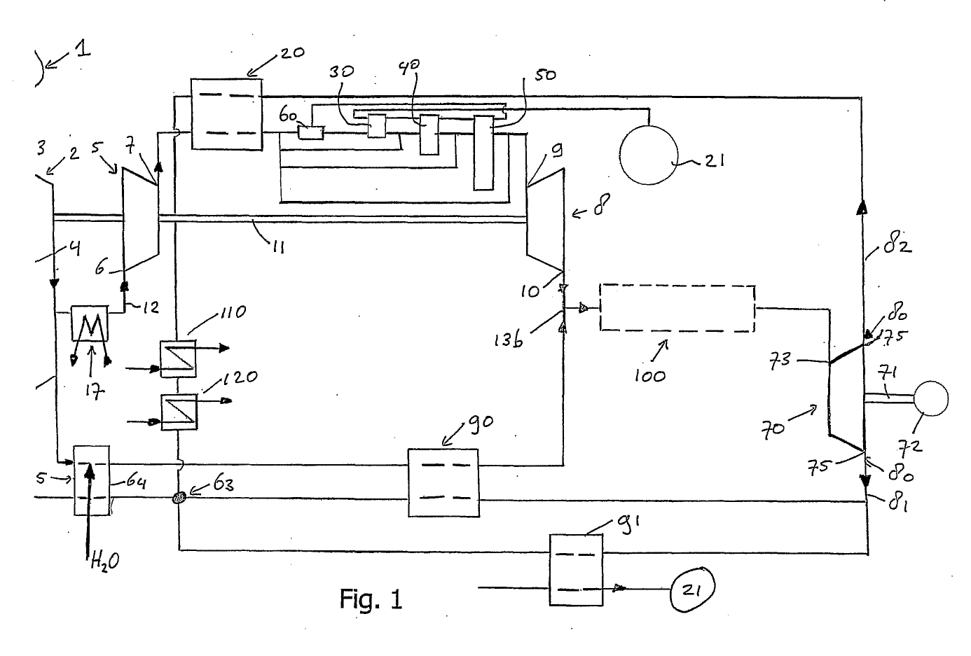

FIG. 1 shows a diagram illustrating a non-limiting exemplary embodiment of the system according to the invention,

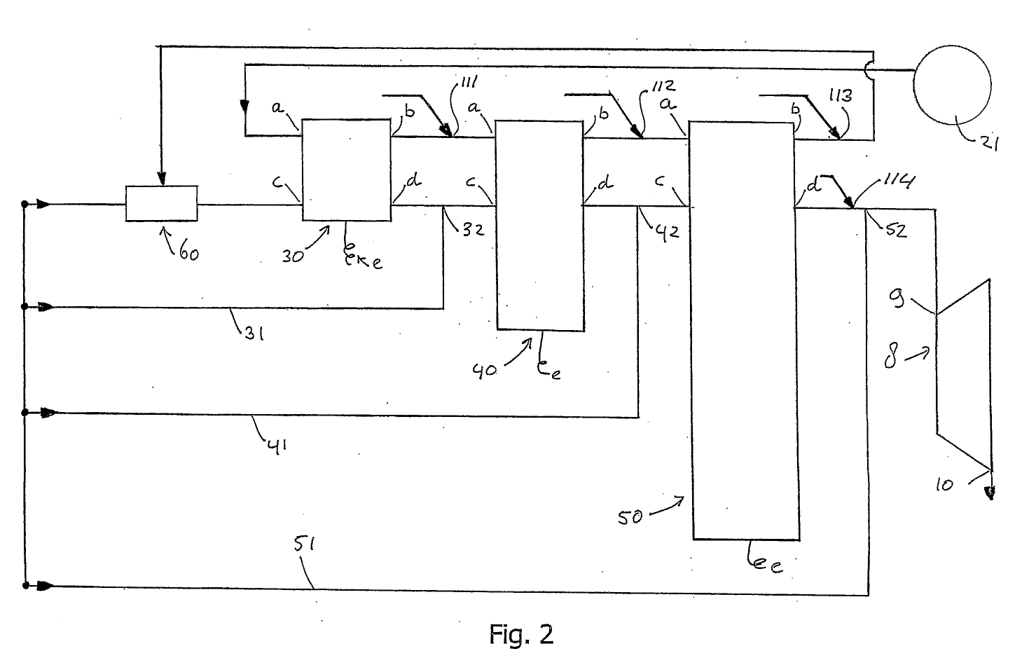

FIG. 2 shows part of the series of high-temperature fuel cells of the system from FIG. 1.

FIG. 1 shows a system for energy generation according to the invention.

The system comprises an air source 1 for air that is to be burnt, in this case ambient air. If appropriate, it would also be possible to provide another source capable of supplying oxygen.

The system also comprises a compressor assembly for compressing the air. In this example, the compressor assembly comprises:
a low-pressure compressor 2 having an air inlet 3 and an outlet 4,
a high-pressure compressor 5 having an inlet 6 and an outlet, the outlet 4 of the low-pressure compressor being connected to the inlet 6 of the high-pressure compressor 5.

Furthermore, the system shown comprises a compressor turbine assembly for driving the low-pressure compressor 2 and the high-pressure compressor 5, which compressor turbine assembly in this case comprises a single compressor turbine 8, and which compressor turbine assembly has an inlet 9 and an outlet 10.

In the present example, the air compressors 4, 5 and the compressor turbine 8 are arranged on a single common shaft 11.

A primary air path 12 extends between the outlet 4 and the inlet 6, via which primary path 12 a primary air stream passes from the low-pressure compressor 2 to the high-pressure compressor 5. An inlet end of a secondary air path 13 is connected to said primary air path 12, in such a manner that, of the compressed air coming out of the outlet 4 of the low-pressure compressor 2, a primary air stream passes to the high-pressure compressor 5 and a secondary air stream passes into the secondary air path 13.

It is preferable for the air stream from the low-pressure compressor 2 to be divided in such a manner that the primary air stream is larger than the secondary air stream; by way of example, the primary air stream amounts to 85% and the secondary air stream 15% of the total air stream. The ratio between the two air streams may be constant, for example by virtue of the secondary air path having a specific passage cross section with respect to the passage cross section of the primary air path 12. It is if appropriate possible to provide control means, for example valve means, preferably in the secondary air path 13, for opening/closing and/or controlling the size of the passage cross section of the secondary air path 13 with respect to the primary air path 12.

At the secondary air path 13 there are first water injection means 15 for injecting water into the secondary air stream.

Cooling means, in this case having a heat exchanger 17, are provided for the purpose of cooling the primary air stream in the primary air path 12.

As is generally known, the injection of water, in whatever way, takes place with a view to cooling the air and increasing the mass flow in the system, which offers various benefits.

Upstream of the first water injection means 15, it is possible to provide a fan at the secondary air path 13 for effecting a limited increase in the pressure of the secondary air stream. This fan may have a low power and may if appropriate be electrically driven.

The system comprises a heat exchanger (or recuperator) 20, which heats air coming out of the outlet of the compressor assembly using heat which is extracted from exhaust gases from the system, as will be explained below.

Between the compressor assembly, in this case downstream of the heat exchanger 20, on the one hand, and the compressor turbine 8, on the other hand, the system comprises a fuel cell arrangement, which is illustrated in more detail in FIG. 2.

The system comprises a fuel source 21 for a fuel, in this example for natural gas, or in a variant hydrogen.

The fuel cell arrangement comprises a plurality of high-temperature fuel cells connected in series for generating at least electrical energy, in particular solid oxide fuel cells (SOFCs).

The example shown depicts a first, second and third high-temperature fuel cell, which are respectively denoted by reference numerals 30, 40 and 50.

These fuel cells 30, 40, 50 are connected in series in the preferred manner presented below.

Each of the fuel cells 30, 40, 50 has an associated anode inlet (a) for a fuel, for example natural gas, and an anode outlet (b), as well as a cathode inlet (c) for air, and a cathode outlet (d), and also an electrical connection for outputting electrical energy (e) which has been generated.

The part illustrated comprises a preheating-combustion device 60 for heating pressurized air coming out of the compressor assembly, which in this case has already been preheated by the heat exchanger 20, so that pressurized heated air is fed to the first fuel cell 30. By way of example, this air is at a pressure of approximately 9 bar and a temperature of 900 degrees Celsius.

The illustration presented in FIGS. 1 and 2 reveals that the cathode inlet (c) of the first fuel cell 30 is connected to the preheating-combustion device 60.

The cathode outlet (d) of the first fuel cell 30 is connected to the cathode inlet (c) of the second fuel cell 40, and the cathode outlet (d) of the second fuel cell 40 is in this case connected to the cathode inlet (c) of the third and in this case last fuel cell 50 in the series.

Furthermore, in this preferred arrangement, the anode inlet (a) of the first fuel cell 30 is connected to the fuel source 21. The anode outlet (b) of the first fuel cell 30 is connected to the anode inlet (a) of the second fuel cell 40, and the anode outlet (b) of the second fuel cell (40) is connected to the anode inlet (a) of the third fuel cell (50).

In this example, the anode outlet (b) of the third fuel cell 50 is connected to the preheating-combustion device 60 for feeding fuel to said combustion device.

Also illustrated in the figures is a bypass air connection 31 for air, which is provided between the air source 1, on the one hand, in this case downstream of the compressor assembly and the heat exchanger 20, and on the other hand an admixing port 31 between the cathode outlet (d) of the first fuel cell 30 and the cathode inlet (c) of the second fuel cell 40.

A similar type of bypass air connection 41 is also provided between the air source 1, in this case downstream of the compressor assembly and the heat exchanger 20, and an admixing port 42 between the cathode outlet (d) of the second fuel cell 40 and the cathode inlet (c) of the third fuel cell 50.

In the present example, a further bypass air connection 51 is provided between the air source 1, in this case downstream of the compressor assembly and the heat exchanger 20, and an admixing port 52 at the cathode outlet (d) of the third and in this case last fuel cell 50 of the series.

The result is a series connection of a plurality of high-temperature fuel cells, with the cathode inlet of each fuel cell being connected to the cathode outlet of the preceding fuel cell, as seen in the direction in which air is supplied, and in which there is a bypass air connection between the air source and an admixing port between the interconnected cathode outlet and cathode inlet of successive fuel cells.

The system also comprises a power turbine 70, in this case with a rotatable shaft 71 for outputting mechanical energy, for example for driving an electric generator 72.

The power turbine 70 has an inlet 73, which in this case is connected to the outlet of the compressor turbine 8.

Between said compressor turbine 8 and the power turbine 70 there is in this case a further series of high-temperature fuel cells (100), preferably having a structure as outlined above. Alternatively, it is possible to provide a low-pressure combustion device.

The power turbine 70 also has an exhaust gas outlet 75.

The installation also has an exhaust gas pipe system, an inlet end 80 of which is connected to the exhaust gas outlet 75 of the power turbine 70. In the diagram, this is illustrated at two locations, for the sake of clarity.

In the present example, an outlet end 13b of the secondary air path 13 is connected to the connection between the outlet 10 of the compressor turbine 8 and the inlet of the arrangement 100 of high-temperature fuel cells or an optional low-pressure combustion device at this position.

The exhaust gas pipe system comprises a primary exhaust gas path 82 and a secondary exhaust gas path 81, which two paths 81, 82 are connected to the outlet 75 of the power turbine 70, so that a primary exhaust gas stream enters the primary exhaust gas path 82 and a secondary exhaust gas stream enters the secondary exhaust gas path 81.

It is preferable for the primary exhaust gas stream to be larger than the secondary exhaust gas stream; by way of example, the ratio between the exhaust gas streams is approximately the same as the ratio between the primary air stream and the secondary air stream.

A secondary air stream heat exchanger 90 transfers heat between the exhaust gases in the exhaust gas pipe system and the secondary air stream, preferably downstream of the water injection means 15.

A fuel-heating heat exchanger 91 transfers heat between the exhaust gas stream and the fuel which is fed to the arrangement of high-temperature fuel cells. Said heat exchanger 91 is preferably incorporated in the secondary exhaust gas stream.

The heat exchanger 20 (also referred to as a recuperator) transfers heat between the primary exhaust gas stream in the primary path 82, on the one hand, and the air stream passing to the series of fuel cells, in this case upstream of the preheating-combustion device 60.

The heat exchangers are preferably designed to extract the maximum possible heat from the exhaust gases before these exhaust gases are discharged. As can be seen at 63, all the streams of exhaust gases converge here.

In the system shown, heat transfer also takes place between the exhaust gas stream and the secondary air stream at the location of or in the immediate vicinity of the water injection 15, in this case by means of heat exchanger 64.

If appropriate, the injected water can be recovered by injecting water in the vicinity of the outlet of the exhaust gas pipe system, which is then collected together with the water injected previously.

In a preferred embodiment, the exhaust gases are passed through a condenser, preferably in such a manner that the exhaust gases pass through one or more curtains of cooling water. This leads to recovery of the injected water and steam, and also scrubs the exhaust gases, so that the system in fact functions without any emissions.

In a variant, a low-pressure combustion device is positioned in the secondary air path 13, for the purpose of burning a suitable mixture of the secondary air stream and a fuel.

The installation shown also illustrates a first and optionally a second steam generator 110, 120, which provides steam. The steam generation is effected partly or completely, which is the preferred option, by the extraction of heat from the exhaust gases. In this case, as is preferred, this extraction takes place downstream of the exhaust gas stream by means of the recuperator 20, in this case from the primary exhaust gas path.

The steam obtained by means of the one or more steam generators 110, 120 of the system is in this case fed via an outlet of said steam generator and via a steam line that is not shown to the outflow from an anode outlet (b) of one or more of the fuel cells in the system. This allows cooling of said outflow and also allows power displacement within the system, which increases efficiency.

The figures also show steam admixing ports 111, 112 (cf. in particular FIG. 2) in the connection between the anode outlet of a fuel cell and the anode inlet of a subsequent fuel cell in the series of fuel cells. It is also possible to see a steam admixing port 113 at the anode outlet (b) of the last fuel cell 50 in the series.

A steam generator is preferably connected to the cathode outlet (d) of the last fuel cell 50 in the series, preferably if a turbine 8 is also connected to said outlet, as in the present example. In this case, it is preferable to provide temperature control means, which allow the steam supply to be controlled in order to set a substantially constant temperature of the supply to said turbine 8. In the present example, steam admixing port 114 is provided for this purpose.

In a variant, it is possible to provide for there to be a plurality of compressor turbines rather than a single compressor turbine, for example in such a manner that one compressor turbine drives the low-pressure compressor and another compressor turbine drives the high-pressure compressor.

In yet another variant, it is possible for a compressor turbine to drive an electric generator and for electric drive motors which are coupled to the electric generator to be provided for the purpose of driving one or more compressors of the compressor assembly.

The injection of water into the secondary air stream and the supply of heat extracted from the exhaust gases to said secondary air stream can also be effected in different ways from that which is shown in the figure. By way of example, one or more heat exchangers may be disposed upstream of the water injection means, or the water injection means may be disposed at the same location as a heat exchanger, or alternatively the water injection means may be disposed between the heat exchangers.

As has already been mentioned above, the water injection can be effected in a wide range of ways depending on the situation, for example in the form of atomized water, steam. In this context, it is pointed out that, although this is less advantageous, it is also possible for water to be injected at the locations of the steam injection described above.

By way of non-limiting example, the text which follows lists the temperatures which may be present in the installation as shown in FIG. 1.
Air coming out of low-pressure compressor 2 125° C.
Air stream downstream of recuperator 20 640° C. at 9 bar.
Air stream after preheating-combustion device 60 900° C.
Air stream at anode outlet (d) of each fuel cell 1100° C.
Air stream after bypass air admixing at 32, 42, 52 900° C.
Exhaust gas stream at power turbine outlet 640° C.

Electrical power of fuel cell 30 210 KW

Electrical power of fuel cell 40 380 KW

Electrical power of fuel cell 50 690 KW

1. System having a plurality of high-temperature fuel cells connected in series for generating at least electrical energy, in particular having Solid Oxide Fuel Cells (SOFCs), which system comprises:
an air source for air,
a fuel source for a fuel, for example natural gas,
at least a first and a second high-temperature fuel cell, which are connected in series, each fuel cell comprising an anode inlet for fuel, and an anode outlet, as well as a cathode inlet for air, and a cathode outlet, as well as an electrical connection for outputting electrical energy which has been generated,
the cathode inlet of the first fuel cell being connected to the air source,
the anode inlet of each fuel cell being connected to the fuel source,
the cathode outlet of the first fuel cell being connected to the cathode inlet of the second fuel cell,
and a bypass air connection for air being provided between the air source, on the one hand, and, on the other hand, an admixing port between the cathode outlet of the first fuel cell and the cathode inlet of the second fuel cell.

2. System according to claim 1, wherein the fuel source is connected to the anode inlet of the first fuel cell, and the anode inlet of the second fuel cell is connected to the anode outlet of the first fuel cell for supplying fuel to the second fuel cell.

3. System according to claim 1, wherein the system comprises one or more additional series-connected high temperature fuel cells, wherein the cathode outlet of a fuel cell is connected to the cathode outlet of a preceding fuel cell when considered in the direction of the air supply, and wherein for each additional fuel cell a bypass air connection is provided between the air source and an admixing port between the cathode outlet of the preceding fuel cell and the cathode inlet of the additional fuel cell.

4. System according to claim 2, wherein the anode inlet of the additional fuel cell is connected to the anode outlet of the preceding fuel cell.

5. System according to claim 1, wherein the system comprises a bypass air connection for air between the air source and the cathode outlet of the last fuel cell of the series of fuel cells.

6. System according to claim 1, wherein between the air source and the cathode inlet of the first fuel cell, the system comprises a preheating device, preferably a combustion device, for heating air originating from the air source, so that heated air is fed to the first fuel cell.

7. System according to claim 6, wherein for the supply of fuel thereto the preheating-combustion device is connected to the anode outlet of one or more fuel cells, preferably of the last fuel cell in the series.

8. System according to claim 1, wherein the system further comprises a turbine which is connected to the cathode outlet of the last fuel cell of the series.

9. System according to claim 1, wherein the system comprises a compressor assembly for compressing air, having at least one compressor with an air inlet and an outlet which is connected to the cathode inlet of the first fuel cell of the series, so that compressed air is fed to said fuel cell and one or more bypass air connections and associated admixing ports of the series of fuel cells.

10. System according to claim 9, wherein the compressor assembly comprises:
a low-pressure compressor with an air inlet and an outlet,
a high-pressure compressor with an inlet and an outlet, the outlet of the low-pressure compressor being connected via a primary air path to the inlet of the high-pressure compressor.

11. System according to claim 9, wherein the system comprises a compressor turbine assembly for driving the compressor assembly, which compressor turbine assembly comprises a single compressor turbine or a plurality of compressor turbines positioned in series, which compressor turbine assembly has an inlet and an outlet, the inlet of the compressor turbine assembly preferably being connected to the cathode outlet of the last fuel cell of the series.

12. System according to claim 1, wherein the system comprises a power turbine for outputting mechanical energy, preferably connected to an electric generator associated with the system for generating electrical energy.

13. System according to claim 11, wherein the power turbine has an inlet which is connected to the outlet of the compressor turbine assembly, and an exhaust gas outlet.

14. System according to claim 11, wherein a combustion device is disposed between the outlet of the compressor turbine assembly and the inlet of the power turbine.

15. System according to claim 11, wherein one or more high-temperature fuel cells, preferably a series of high-temperature fuel cells according to claim 1, are disposed between the outlet of the compressor turbine assembly and the inlet of the power turbine.

16. System according to claim 13, wherein the system comprises an exhaust gas pipe system, an inlet end of which is connected to the exhaust gas outlet of the power turbine.

17. System according to claim 10, wherein the system comprises a secondary air path, which at an inlet end thereof is connected between the outlet of the low-pressure compressor and the inlet of the high-pressure compressor, in such a manner that, of the compressed air coming out of the outlet of the low-pressure compressor, a primary air stream passes via the primary air path to the high-pressure compressor and a secondary air stream enters the secondary air path, and wherein preferable the secondary air path, at an outlet end thereof, is connected to the connection between the outlet of the compressor turbine assembly and the inlet of the power turbine.

18. System according to claim 1, wherein the system comprises water injection means, preferably for injecting water into the secondary air path according to claim 17.

19. System according to claim 17, wherein in the secondary air path a fan is incorporated for increasing the pressure of the secondary air stream.

20. System according to claim 16, wherein the system comprises a heat exchanger which effects heat transfer between the exhaust gases in the exhaust gas pipe system, on the one hand, and the secondary air stream, on the other hand, preferably downstream of possible water injection means.

21. System according to claim 1, wherein an exhaust gas pipe system comprises a primary exhaust gas path and a secondary exhaust gas path, which connect to an outlet of the turbine, preferably a power turbine, such that a primary exhaust gas stream comes into the primary exhaust gas path and a secondary exhaust gas stream comes into the secondary exhaust gas path, wherein a heat exchanger or recuperator effects heat exchange from the primary exhaust gas path to the air supply to the series of high temperature fuel cells, and the possible secondary air stream effects a heat exchange between the secondary exhaust gas stream and the secondary air stream.

22. System according to claim 1, wherein a heat exchanger is provided for heating the fuel for the series of high temperature fuel cells.

23. System according to claim 1, wherein the system comprises one or more steam generators for generating steam, in which case a steam generator is preferably connected to the exhaust gas pipe system for the purpose of making use of heat from the exhaust gases in order to create steam, preferably downstream of a possible heat exchanger or recuperator, wherein the steam generator has an outlet which is connected to the anode outlet of one or more of the fuel cells, preferably to an admixing port in the connection between the anode outlet of a fuel cell and the anode inlet of a following fuel cell in the series of fuel cells.

24. System according to claim 1, wherein the system comprises a steam generator for generating steam, wherein the steam generator is preferably connected to the exhaust gas pipe system for utilizing heat from the exhaust gases to create steam, and wherein the steam generator has an outlet which is connected to the cathode outlet of the last fuel cell in the series, wherein preferably said outlet is connected to a turbine, and wherein preferably temperature control means are provided that allow for a control of the steam supply for the purpose of setting an essentially constant temperature of the supply to said turbine.

25. System according to claim 10, wherein the system comprises a fourth heat exchanger for cooling the primary air stream between the outlet of the low-pressure compressor and the inlet of the high-pressure compressor, which fourth heat exchanger preferably is incorporated in a feed water conduit of a steam generator of the system and/or water injection means for heating said feed water.

26. System according to claim 10, wherein the compressor turbine assembly has a single compressor turbine which is mounted on a shaft in common with a compressor, for example a low-pressure compressor and high-pressure compressor when present.

27. System according to claim 10, wherein the compressor turbine assembly drives an electrical generator, and wherein for driving the one or more compressors of the compressor assembly electrical drive motors are provided which are coupled to the electrical generator.

28. System according to claim 1, wherein the series of high temperature fuel cells is combined with a downstream arranged (gas)turbine, which is possibly provided with one or more of the following aspects: intermediate compressor cooling, recuperation, reheating of the medium supplied to the turbine, waterinjection, steaminjection, single or multiple shaft embodiment of the turbine.

29. System according to claim 1, wherein the series of high temperature fuel cells is used in a drying system for establishing a drying process, for example a hot-air drying process or in a system in combination with a combustion vessel, for instance a furnace in the chemical industry.

30. System according to claim 1, wherein the system is a heat-power system for generating heat and electrical power.

31. System according to claim 1, wherein the series of high temperature fuel cells is embodied as a stand-alone energy generation system, for example for generating electrical power.

32. System according to claim 1, wherein the system comprises a condensor for exhaust gases, for example a condensor wherein the exhaust gases pass through a water curtain one or more times with cooling water, which cooling water is possibly returned to one or more water injection means and/or steam generators of the system.
